(19) United States
(12) Patent Application Publication
(10) Pub. No.: US 2013/0160264 A1
(43) Pub. Date: Jun. 27, 2013

(54) Plumbing tool

(71) Applicant: Wayne Reyes, Costa Meza, CA (US)

(72) Inventor: Wayne Reyes, Costa Meza, CA (US)

(21) Appl. No.: 13/374,312

(22) Filed: Dec. 21, 2011

(51) Int. Cl. B25B 27/00

(52) U.S. Cl. 29/278

(57) ABSTRACT

A spud tool for use by a plumber to install and to remove plumbing feed water spuds includes an elongate tubular socket-like body internally recessed and provided with wrenching flats; and a captive coaxial stem having a cruciform head disposed both axially-movably and relatively-rotationally within the recess of the socket-like body. The stem at an end opposite to the cruciform head carries a handle portion for application of manual torque, and the handle portion is slidably movable from side-to-side of the stem in order to allow a wrench head to be slipped along the handle portion and onto the stem in order to achieve driving engage with the socket-like body.

### BACKGROUND OF THE INVENTION

1. Field of the Invention

The present invention relates generally to a tool for use by a plumber. More particularly, the present invention relates to a specialized tool used by a plumber to install and remove specialized plumbing fittings known as “spuds.” There are many types of plumbing spuds, including those used to make drain connections to shower pans, and those used to make drain connections to bathtubs. Another type of plumbing spud is utilized in various sizes to make feed water connections into porcelain fixtures, such as for porcelain toilets and urinals commonly found in commercial and industrial restrooms. Such feed water plumbing spuds consist of an inner tubular part made of brass and defining a bore along which feed water is supplied to the fixture. Outwardly, this inner tubular part defines a fine-pitch screw thread leading to an outwardly tapering (i.e., conical) surface upon which is carried an expansible grommet formed of polymer or of rubber. A fine-pitch, thin-wall nut is threadably received upon the inner tubular part, and when these parts are threaded together, they are effective to expand the grommet into sealing engagement with a feed water opening of a porcelain fixture, without damaging the porcelain.

2. Related Technology

Those ordinarily skilled in the pertinent arts will understand that prior to the present invention, when a plumber needed to install a feed water plumbing spud of the type described above, he generally used a lever, such as a large screw driver, which he wedged into the bore of the feed water plumbing spud and engaged against internal tangs of this part. The internal tangs of the feed water plumbing spud are intended to keep a water supply pipe from slipping too deeply into the feed water plumbing spud. But, these tangs are available on a new feed water plumbing spud as an expedient when engaged as described in order to keep the internal tubular part of the feed water plumbing spud from turning in the fixture. With the feed water plumbing spud thus immobilized in the water feed opening of the porcelain fixture, the plumber then generally used a large pair of pliers or similar type of tool (i.e., a large ChanneLock™ type of pliers) to tighten the nut on the feed water plumbing spud. This procedure is awkward even when installing a new feed water plumbing spud because of the limited space and access within which the plumber frequently must work in many situations. That is, the porcelain fixture upon which the plumber must work if frequently installed in a confined space or stall, close to or upon a wall, and the top of the fixture at which the feed water hole is defined frequently is recessed or is obscured by other adjacent structures, and as a result is difficult to access. When the top of the porcelain fixture is both close to a wall and recessed below closely spaced obstacles, a large pliers tool is very difficult to utilize and damage to the feed water plumbing spud frequently results.

But, even more difficulty is encountered when a plumber must remove a feed water plumbing spud which has been in place for many years—especially if it is inaccessible as described in the preceding paragraph. In this case, corrosion and accumulation of minerals from water will most likely have made the inner tubular part and nut of the feed water plumbing spud very difficult to turn relative to one another. As a result, the feed water plumbing spud is very difficult to loosen and remove from the porcelain fixture. In that case, a screwdriver or other lever wedged into the bore of the feed water plumbing spud will not generally provide sufficient grip on the feed water plumbing spud in order to prevent the inner tubular part from turning when the plumber attempts to unscrew the nut. So, a common expedient is for the plumber to use two pair of large pliers, usually of the ChanneLock™ type, with one gripping on the exposed threads of the feed water plumbing spud, and the other gripping on the nut, so that the feed water plumbing spud parts can be loosened and removed from the porcelain fixture. Of course, gripping the feed water plumbing spud in this way (i.e., on the exposed fine-pitch screw threads) both ruins these threads so that the feed water plumbing spud can not likely be re-used, but also makes loosening and removal of the nut (which is threaded on these exposed threads) much more difficult as damage to the screw threads progresses. It is apparent that the more difficult the feed water plumbing spud is to remove, the more the fine-pitch screw threads will be damaged, and the more difficult it will be as a result to sufficiently loosen the fine-pitch nut along these damaged screw threads. In especially difficult cases, the plumber is forced to destroy the old feed water plumbing spud in order to remove it while attempting to not also damage the porcelain fixture. This can be a very time consuming job for the plumber.

As a result of the difficulties briefly described above, the job of removing a feed water plumbing spud from a porcelain fixture, which facially appears to be a simple task, can become difficult and very time consuming.

### SUMMARY OF THE INVENTION

In view of the deficiencies of the conventional related technology, it is an object of this invention to overcome or reduce one or more of these deficiencies.

Accordingly, one particularly preferred embodiment of the present invention provides a feed water plumbing spud tool which is especially configured to work quickly and easily in confined, recessed, and inaccessible spaces, and which will easily install, (and more importantly—easily remove) feed water plumbing spuds of the type described above.

Further, an object for this invention is to provide such a feed water plumbing spud tool which essentially does not damage even older corroded feed water plumbing spuds, and allows their removal from a porcelain fixture quickly and with minimal damage so that the feed water plumbing spud can be re-used.

It follows that by use of the present inventive feed water plumbing spud tool, that a plumber may be both more productive, and incur far less risk of damaging a porcelain fixture such as a commercial or industrial type of toilet or urinal while installing or removing a feed water plumbing spud at the fixture.

Other objects, features, and advantages of the present invention will be apparent to those skilled in the art from a consideration of the following detailed description of two preferred exemplary embodiments thereof taken in conjunction with the associated figures which will first be described briefly.

### BRIEF DESCRIPTION OF THE DRAWING FIGURES

FIGS. 1-4, respectively provide top plan, side elevation, side elevation, and bottom views of a feed water plumbing spud tool according to this present invention;

FIGS. 5 and 5A, respectively provide a diagrammatic exploded view (partially in cross section), and a fragmentary plan view taken at line 5A-5A of FIG. 5; and

FIG. 6 is an assembly view, partially in cross section, of a feed water plumbing spud tool according to this invention in engagement with a feed water plumbing spud at a porcelain fixture.

### DETAILED DESCRIPTION OF AN EXEMPLARY PREFERRED EMBODIMENT OF THE INVENTION

While the present invention may be embodied in many different forms, disclosed herein is a specific exemplary and preferred embodiment which illustrates and explains the principles of the invention. It should be emphasized that the present invention is not limited to the specific embodiment illustrated.

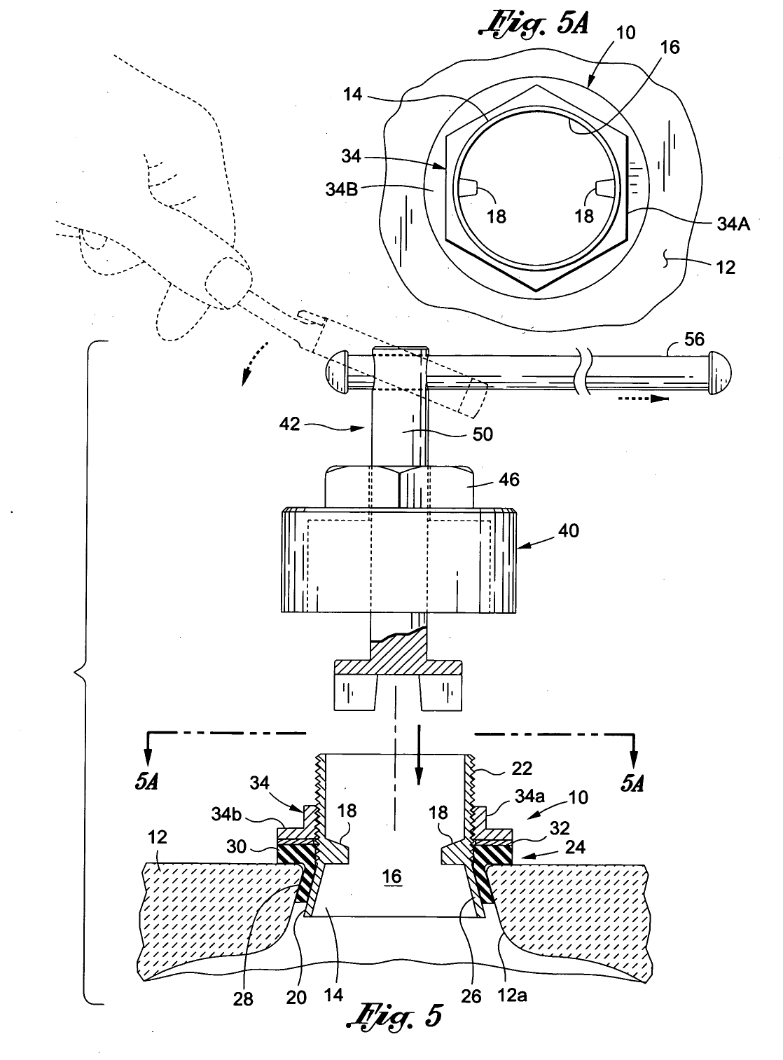

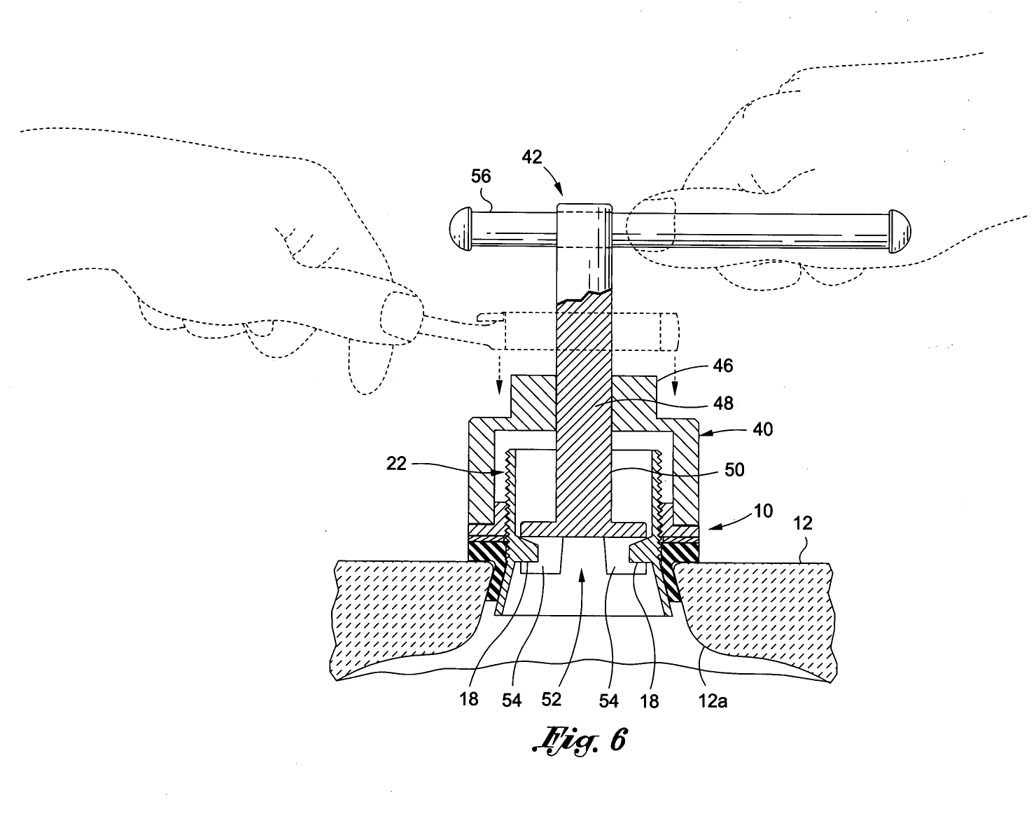

In order to provide a background, or context, for the present invention and its use, attention is directed first of all to FIGS. 5, 5A, and 6, in which a feed water plumbing spud 10 of the type particularly addressed by the present invention is shown installed upon a porcelain fixture 12. The fixture 12 defines an upper water feed opening 12A, at which water (i.e., from a flush valve—not shown in the drawing Figures) is received. The porcelain fixture 12 is shown in fragmentary cross sectional view in FIGS. 5 and 6, and could be a urinal fixture or toilet fixture of the type commonly found in commercial and industrial rest rooms. Also, while feed water plumbing spuds of the type illustrated are commonly available in various sizes, it is to be understood that three common sizes are most frequently encountered. Thus, a feed water plumbing spud tool according to this invention may be implemented in any one of three differing sizes in order to provide comprehensive utility for a plumber in installing and removing these three commonly encountered sizes of feed water plumbing spuds. It is anticipated that a set of three such feed water plumbing spud tools according to this invention will be utilized by a plumber as part of his service kit of tools which he takes along to job sites in order to do plumbing work.

Viewing FIGS. 5, 5A, and 6, it is seen that the feed water plumbing spud 10 includes a thin-walled tubular inner part 14 defining a through bore 16 providing for water inflow to the porcelain fixture 12. Within this bore 16 a pair of diametrically opposed tangs 18 protrude radially inwardly for the purpose of preventing the lower end of a water inflow pipe (not shown—which is received from above downwardly into the feed water plumbing spud 10) from dropping or extending too far downwardly into the fixture 12. Outwardly, the tubular part 14 defines both a conical tapering surface 20 and an elongate fine-pitch screw-thread surface 22. Over the screw-thread surface and upon the tapering surface 20 is received an elastomeric grommet 24 inwardly having a tapering surface 26 matching the surface 20. This grommet 24 is expansible when forced along the tapering surface 20 and defines a depending lip 28 for sealing receipt into the upper water inflow opening 12A of the porcelain fixture 12. The grommet 24 also defines an upwardly disposed shoulder 30 engaged first by a washer 32 and by a thin-walled nut 34 threadably engaged upon the fine-dimension thread of the tubular inner part 14. The thin-walled nut defines wrenching flats 34A disposed above an integral shoulder portion 34B of this thin-walled nut which bears upon the washer 32.

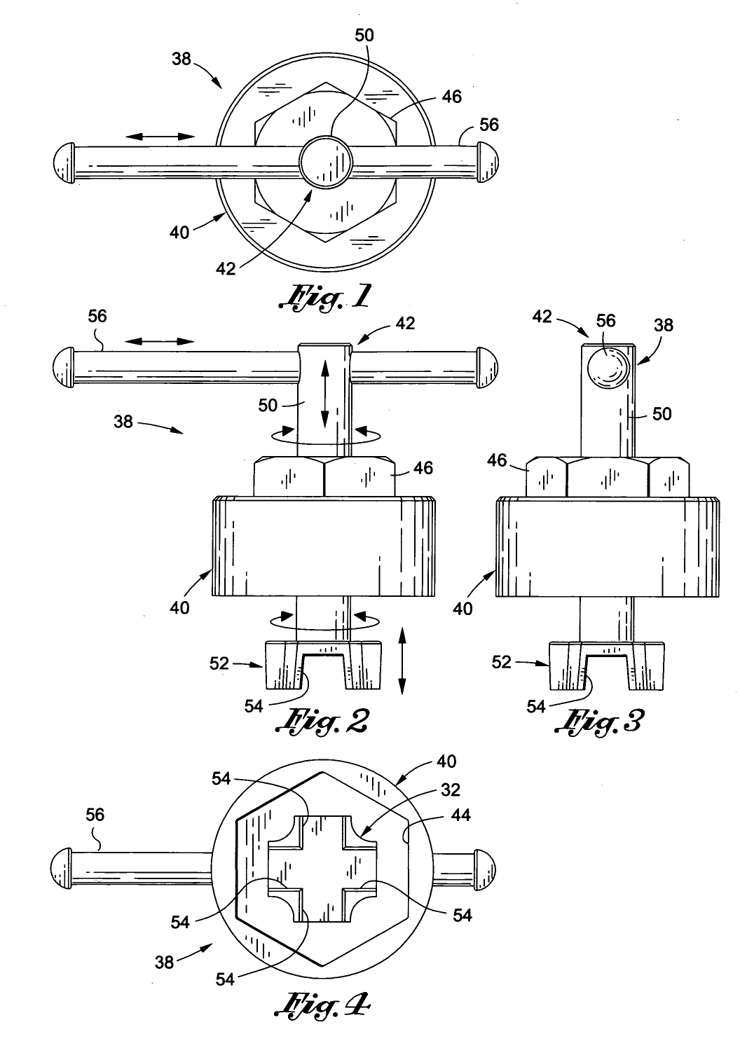

Turning first to FIGS. 1-4 considered in conjunction with one another (while also giving attention to FIGS. 5, 5A, and 6), a feed water plumbing spud tool 38 (i.e., the tool) according to this invention includes two major relatively rotatable and permanently united parts 40 and 42. Part 40 is configured generally as a robust deep-well socket-like structure inwardly defining a recess 44 best seen in FIG. 4. This recess 44 is hexagonal in axial end view (i.e., FIG. 4) and is sized to drivingly receive the wrenching flats 34A of a feed water plumbing spud. Thus, the socket part 40 may drivingly engage the thin-walled nut of a feed water plumbing spud. But, very importantly for utility and ease of use of the tool, the socket part 40 also is comparatively tall, so that a recessed feed water plumbing spud may be addressed easily by a plumber. That is, at an elevation above that of the thin-walled nut 34 the socket part 40 externally defines a hexagonal set of wrenching flats 46. The wrenching flats 46 are also of a considerably smaller size than the thin-walled nut 34, so that a tool of more convenient size may be used in confined spaces.

As is best seen in FIG. 6, the socket part 40 co-axially defines a bore 48, and part 42 is rotationally received (i.e., journaled) for rotational and axial relative movement within the bore 48 (viewing the relative movement arrows provided on FIG. 2). The part 42 includes an elongate stem 50 rotationally and axially movable in the bore 48 (and thus rotationally and axially movable relative to socket part 40). At its lower extent or termination, the stem 50 integrally defines and carries an enlarged cruciform head 52, defining at least one (but preferably defining two), transverse diametrical slots 54. These slots 54 are sized to receive and drivingly engage the tangs 18 of a feed water plumbing spud, as is best seen also in FIG. 6. Because both of the tangs are engaged simultaneously, which is not the case when a plumber uses a lever, pry bar, or screw driver wedged into a feed water plumbing spud to immobilize the inner part, the driving engagement of the cruciform head 52 with the inner tubular part of a feed water plumbing spud is much improved, and the likelihood of damage to the feed water plumbing spud is greatly reduced. This is especially important when a plumber is attempting to remove an old, corroded feed water plumbing spud.

Adjacent to its upper extent, the stem 50 carries a rod-like handle 56, which is captive, but which importantly is configured to allow it to slide from side to side within the confines of its opposite headed ends, as is indicated by the movement arrows on FIG. 2. Thus, it will be understood that the tool 38 has no loose or removable parts (especially no small or fragile parts) which can be misplaced or become lost at a job site.

Having observed the details of construction of the feed water plumbing spud tool 38, further attention to FIGS. 5, 5A, and 6 will illuminate how the tool 38 is used, and how its features result in a remarkable utility and ease of operation for a plumber. As is seen in FIG. 5, in preparation for using the tool 38 a plumber may move the handle 56 entirely or substantially to one side (or extent) of its sliding movement in stem 50, allowing the head of a box end wrench (shown in phantom line in FIGS. 5 and 6) to be moved along the handle 56, and to be rotated about stem 50 and then downwardly along the stem 50 to drivingly engage on the wrenching flats 46 of the socket part 40. Experience with prototypes of the tool have shown that a ratcheting box end wrench, preferably with a comparatively short handle, provides great ease of operation of the tool 38 even in the most confined and inaccessible locations which may be encountered by a plumber.

Next, as is seen best in FIG. 5, and as illustrated by the movement arrow on this drawing Figure, the plumber engages the tool 38 with the feed water plumbing spud 10. The cruciform head 52 engages onto the pair of tangs 18 and at the handle 56 provides purchase at an elevation well above the plumbing feed water spud for the plumber to restrain the inner tubular part 14 of the plumbing feed water spud 12 against undesired rotation. Similarly, the wrench (i.e., possibly and preferably a ratcheting box end wrench) used by the plumber engages on the outer socket part, also at an elevation well above the plumbing feed water spud so that the plumber may effect powerful rotation of the nut 34. In both cases (i.e., at handle 56, and at the wrench handle acting on socket part 40), as is illustrated in FIG. 6, the plumber is able to work above or spaced from any recess or restricted access that may exist at the location of the plumbing feed water spud 10 itself. Thus, a previously difficult job is made much easier by the present invention.

Considered further, and viewing FIG. 6 in particular, it is seen that this Figure illustrates the tool 38 in use to install or remove a feed water plumbing spud, with the plumber having excellent engagement and torque-application access with the inner tubular part of the feed water plumbing spud via the stem 50 with its cruciform head 52 and handle 56. Similarly, the use of a ratcheting box end wrench on the socket part 40 allows the plumber to quickly and easily tighten or loosen the nut 34 without having to use a pliers type of tool. As a result, although such feed water plumbing spuds are generally made of brass, which is a relatively soft metal, the driving engagement offered by the tool 38 takes best advantage of the features of the feed water plumbing spud so as to not damage it during installation, or even during a difficult removal. Again, heretofore, plumbers were forced to use a pliers type of tool, or a pair of such pliers type tools, and such pliers type tools require the plumber to: engage with the nut 34, rotate this nut, remove the tool from engagement, and successively re-engage an un-wieldy tool such as a large pliers tool working in an area allowing only confined access to the plumbing feed water spud. Especially when a feed water plumbing spud is to be removed, especially one which is corroded or caked with minerals from long exposure to water, the conventional expedient was both difficult and likely to damage or destroy the feed water plumbing spud. With the present tool 38 a feed water plumbing spud, even a corroded one, can almost always be removed without damage, and can be re-used. That is, the fine-dimension screw threads on the outside of the plumbing spud are not gripped in any way by the present tool, and these threads are generally kept intact by use of the present tool, so that (with the replacement of the elastomeric grommet 24), the metal parts of a feed water plumbing spud can be re-used.

Those skilled in the art will further appreciate that the present invention may be embodied in other specific forms without departing from the spirit or central attributes thereof. Because the foregoing description of the present invention discloses only one particularly preferred exemplary embodiment of the invention, it is to be understood that other variations are recognized as being within the scope of the present invention. Accordingly, the present invention is not limited to the particular embodiment described in detail herein. Rather, reference should be made to the appended claims to define the scope and content of the present invention.

I claim:

1. A plumbing feed water spud tool, said tool comprising:
an elongate tubular socket-like member defining a recess opening axially at one end and inwardly being provided with wrenching flats for drivingly engaging upon a nut of a plumbing feed water spud, said socket-like member also defining a coaxial bore extending from said recess and axially opening oppositely from said recess, a boss portion circumscribing said opening of said bore and said boss outwardly being provided with wrenching flats at a size smaller than said nut of said plumbing feed water spud;
a stem member captively received in said bore for axial and rotational movement relative to said socket-like member, said stem at one end defining a head portion in juxtaposition with and movable into said recess, and said head portion defining at least one transverse diametrical slot for driving engagement with radially extending internal tangs of said plumbing feed water spud, said stem at an opposite end portion thereof carrying a transverse rod-like handle portion captively retained in side-to-side sliding relationship with said stem and providing manual purchase for application of torque to said stem,
whereby, said handle portion is slidable toward one extreme of its motion relative to said stem such as to allow a box-end wrench to be moved along said handle portion and onto said stem member to engage drivingly upon said wrenching flats of said boss portion, so that the box end wrench may apply opposing torque to said tubular socket-like member.

2. The plumbing feed water spud tool of claim 1, wherein said tool disposes both said rod-like handle portion and said boss at which a box-end wrench is engageable at respective locations spaced axially of said plumbing feed water spud from the nut of said plumbing feed water spud.

3. The plumbing feed water spud tool of claim 1, wherein said head portion is cruciform in configuration, and defines a pair of orthogonal diametrical slots for driving engagement with radially extending tangs of a plumbing feed water spud.

4. The plumbing feed water spud tool of claim 1, wherein said head portion is integral with said stem and is larger in size than said bore and will not pass through said bore, whereby said stem is captive in said bore by reason of said head portion not being able to pass through said bore.

5. The plumbing feed water spud tool of claim 1, wherein said rod-like handle portion is slidably received in a transverse boring defined by said stem member, and said handle portion being headed at each opposite end to be permanently captive in said boring of said stem member, whereby said stem member is captive in said bore by reason of said handle portion not being possible to pass through said bore.

6. A unitary plumbing feed water spud tool having no removable parts or parts necessary to be assembled before the tool can be used, and said tool providing to a user a pair of manual purchase locations both spaced axially from and axially of said plumbing feed water spud at which opposing torques may be applied to said plumbing feed water spud, said tool comprising:
an elongate tubular socket-like member defining a recess opening axially at one end and inwardly being provided with wrenching flats for drivingly engaging upon a nut of a plumbing feed water spud, said socket-like member also defining a coaxial bore extending from said recess and axially opening oppositely from said recess, a boss portion circumscribing said opening of said bore and said boss outwardly being provided with wrenching flats at a size smaller than said nut of said plumbing feed water spud;
a stem member permanently captively received in said bore for axial and rotational movement relative to said socket-like member, said stem at one end defining a head portion in juxtaposition with said recess, and said head portion defining at least one transverse diametrical slot for driving engagement with radially extending internal tangs of said plumbing feed water spud, said stem at an opposite end portion thereof carrying a transverse rod-like handle portion permanently captively retained in side-to-side sliding relationship with said stem and providing manual purchase for application of torque to said stem; said head portion being integral with said stem and of a size larger than said bore, and said rod-like handle portion is slidably received in a transverse boring defined by said stem member, and said handle portion being headed at each opposite end to be permanently captive in said boring of said stem member;
whereby, said handle portion is slidable toward one extreme of its motion relative to said stem such as to allow a box-end wrench to be moved along said handle portion and onto said stem member to engage drivingly upon said wrenching flats of said boss portion, so that the box end wrench and said handle portion provide manual purchase to apply opposing torques to said plumbing feed water spud.

7. A spud tool comprising: coaxial socket and handle members permanently united and captively retained in relative axial and rotational relation to one another, said socket member being elongate and at one axial end defining an axial recess provided with wrenching flats for drivingly engaging upon a nut of a spud, said socket member also defining a bore coaxial with said recess and extending from said recess to open axially on an opposite end of said socket member, a boss portion of said socket member circumscribing said opening of said bore and said boss outwardly being provided with wrenching flats, said handle member including a stem permanently captively received in said bore for axial and rotational movement relative to said socket member, said stem at one end defining a head portion in juxtaposition with said recess, and said head portion defining at least one transverse diametrical slot for driving engagement with radially extending internal tangs of a spud, said stem adjacent to an opposite end thereof carrying a transverse rod-like handle portion permanently captively retained on said stem and providing manual purchase for application of torque to said stem; whereby said handle portion and said head portion in conjunction prevent said stem from being separated from said socket member.
